(19) United States
(12) Patent Application Publication
(10) Pub. No.: US 2010/0030576 A1
(43) Pub. Date: Feb. 4, 2010

(54) System and Method for Pain Management

(75) Inventor: Justin L. Gregory, Belton, TX (US)

Correspondence Address: CONLEY ROSE, P.C., 5601 GRANITE PARKWAY, SUITE 750, PLANO, TX, 75024, US

(73) Assignee: MCLANE ADVANCED TECHNOLOGIES, LLC, Temple, TX (US)

(21) Appl. No.: 12/182,671

(22) Filed: Jul. 30, 2008

(51) Int. Cl. G06Q 50/00; G06F 17/30

(52) U.S. Cl. 705/3; 707/104.1; 707/E17.002

(57) ABSTRACT

A pain management system is provided. The pain management system comprises a database and a pain management server. The database contains a plurality of pain scores associated with a first patient. The pain management server is in communication with the database and comprises a processor and a pain management application. The pain management application, when executed by the processor, receives a first pain score associated with the first patient, analyzes the first pain score based at least in part on the plurality of pain scores associated with the first patient in the database, and when the first pain score drops below a first threshold determined by the analysis, raises an alert. The pain management system promotes control of administration of pain medication to the first patient.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Pain is a very common experience. As the United States' population ages, pain experiences may be expected to grow in frequency, with a significant portion of the population experiencing chronic pain in the form of cancer, arthritis, and other ailments. Acute pain may be experienced temporarily in association with trauma, surgery, and others. Increasing attention has recently been brought to the subject of pain and pain management. In some cases pain is often unnecessary and avoidable and/or controllable with appropriate pain medication. The Joint Commission on Accreditation of Healthcare Organizations (JCAHO) has made pain control a factor in the determination of a healthcare quality of care indicator.

### SUMMARY

In an embodiment, a pain management system is disclosed. The pain management system comprises a database and a pain management server. The database contains a plurality of pain scores associated with a first patient. The pain management server is in communication with the database and comprises a processor and a pain management application. The pain management application, when executed by the processor, receives a first pain score associated with the first patient, analyzes the first pain score based at least in part on the plurality of pain scores associated with the first patient in the database, and when the first pain score drops below a first threshold determined by the analysis, raises an alert. The pain management system promotes control of administration of pain medication to the first patient.

In another embodiment, a method of pain management is disclosed. The method comprises analyzing a plurality of pain scores associated with a first patient to determine a standard deviation of the pain scores, receiving a current pain score associated with the first patient, and when the current pain score drops below a first threshold defined based on the standard deviation of the pain scores, transmitting a first alert message.

In yet another embodiment, a method of pain management equipment maintenance is disclosed. The method comprises receiving a plurality of pain scores associated with one or more patients receiving pain medication from a first controlled medication delivery system and analyzing the pain scores to identify a signature of pain scores associated with a performance degradation of the first controlled medication delivery system. The method also comprises, when the signature of pain scores associated with the performance degradation of the first controlled medication delivery system is identified, removing the first controlled medication delivery system from service for one of performance of maintenance and decommisioning.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a pain management system according to an embodiment of the disclosure.

FIG. 2 is a flow chart of a pain management method according to an embodiment of the disclosure.

FIG. 3 is a flow chart of a controlled medication delivery system maintenance method according to an embodiment of the disclosure.

FIG. 4 is an illustration of a handset according to an embodiment of the disclosure.

FIG. 5 is a block diagram of a handset according to an embodiment of the disclosure.

FIG. 6 is a block diagram of an exemplary software architecture of a handset according to an embodiment of the disclosure.

FIG. 7 is a block diagram of an exemplary general purpose computer system suitable for implementing some aspects of the several embodiments of the disclosure.

### DETAILED DESCRIPTION

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents.

In the recent past, patient pain, for example pain experienced by patients receiving medical treatment at a hospital or other healthcare facility, has not been tracked and recorded in a form amenable to computer storage and processing. Formerly, patient pain has been stored in verbose textual descriptions not readily searched and/or processed algorithmically. The present disclosure teaches capturing patient pain scores in a format amenable to processing by a computer and using the captured patient pain scores to better manage patient pain to achieve a higher overall patient satisfaction. The pain scores may include a pain numerical value as well as a complication score. In an embodiment, the complication score may include a complication type value and a complication numerical value. Various contextual information may be linked with the pain scores, for example a patient complaint or condition, a patient medical history, a pain medication delivery point, a type of pain medication delivery mechanism used to medicate the patient, a pain management plan, and other. The pain medication delivery point may include the location of an infusion tap, such as an epidural drip between two adjacent vertebrae. At the end of a pain management stay, such as after a hospital stay, an overall patient satisfaction metric may be calculated based on the pain scores. The overall patient satisfaction metric may be based on one or more of a maximum pain numerical value, an average of pain scores for a patient, an aggregate of slope values of the delta between pain scores, a stability and/or steadiness of the pain numerical values, a presence of complications, the complication type values, the complication numerical values, and others.

In an embodiment, the current pain experienced by a patient is provided by the patient as a current pain numerical value and is compared against previous pain numerical values provided by the patient. If the current pain numerical value drops too much with respect to the previous pain numerical values, an alert message is generated and transmitted to attending medical personnel, for example a nurse, an anesthesiologist, and/or a physician. The attending medical personnel may come to inspect the patient and to adjust a medication delivery mechanism in response to receiving the alert message. A sudden drop in pain may indicate an excess dosage of pain medication has been delivered due to a faulty controlled medication delivery mechanism, such as an epidural infusion pump, a nerve block pump, and a patient-controlled analgesia (PCA) pump, or due to some other cause. In another embodiment, if the current pain numerical value rises too much with respect to the previous pain numerical values, an alert message is generated and transmitted to attending medical personnel. In an embodiment, the current pain numerical value may be compared against an average determined over the previous pain numerical values of the patient, and when the current pain numerical value differs from the average by a standard deviation, either a standard deviation below the average or a standard deviation above the average, the alert message is generated and transmitted. In some embodiments, other thresholds for generating and transmitting the alert message may be employed, for example two standard deviations or a fractional number of standard deviations. A standard deviation is a well known statistical analysis concept. The standard deviation is a measure of how dispersed or concentrated a set of values is. In some embodiments, alternative references other than the average pain numerical value may be employed, for example a median pain numerical value, a mode of the set of previous pain numerical values, a sliding window average, or other calculated reference. In other embodiments, the pain scores may be compared to a normal pain score reference associated with a specific procedure, pain treatment plan, and/or injury.

In an embodiment, a controlled medication delivery system, such as an epidural infusion pump, a nerve block pump, and a patient-controlled analgesia pump may be employed to deliver pain medication to the patient. By analyzing a set of pain scores associated with a specific type of controlled medication delivery system, the present disclosure contemplates that a signature, pattern, or trend of a sequence of pain scores may be determined that can be associated with a degradation of performance of the specific type of controlled medication delivery system. Once the indicative pain score signature has been determined, the signature may be used to analyze a sequence of pain scores provided by the patient or by a sequence of patients treated using the same controlled medication delivery system to prospectively identify that the controlled medication delivery system, for example a specific epidural infusion pump, is beginning to experience degraded performance. The controlled medication delivery system, for example the specific epidural infusion pump, may then be replaced by a properly functioning controlled medication delivery system, and the degraded controlled medication delivery system either maintained, for example undergoing an overhaul procedure, or decommissioned from service.

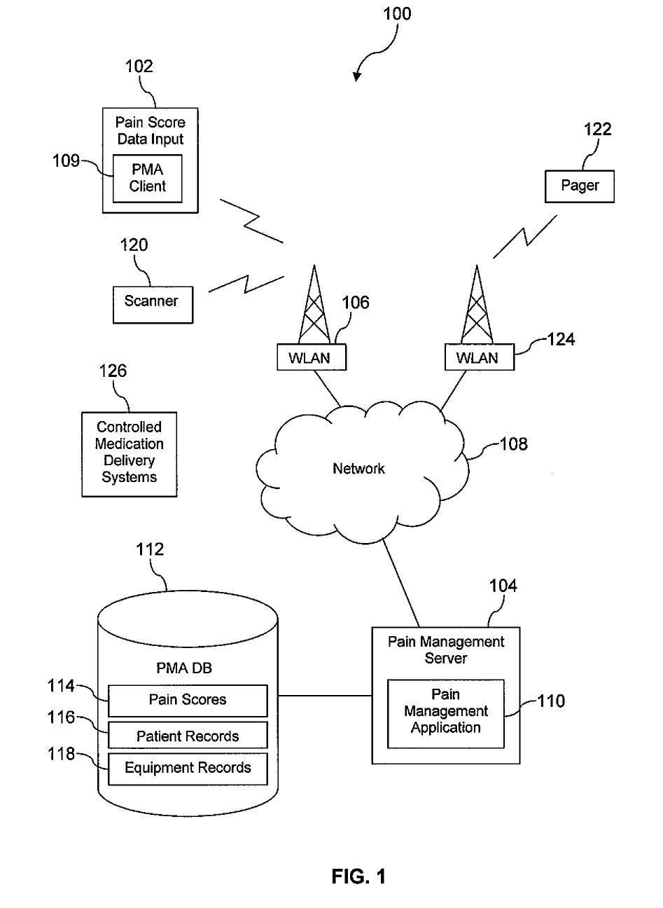

Turning now to FIG. 1, a pain management system 100 is described. The system 100 comprises a pain score data input device 102, a pain management server 104, a first wireless access point 106, a network 108, a pain management application (PMA) 110, a pain management application (PMA) database 112, a set of pain scores 114, a set of patient records 116, and a set of equipment records 118. The system 100 may also comprise a scanner device 120, a pager device 122, and a second wireless access point 124. The system 100 may also comprise a controlled medication delivery system 126. The pain management system 100 may comprise any number of pain score data input devices 102, scanner devices 120, pager devices 122, and controlled medication delivery systems 126. While two wireless access points 106, 124 are illustrated in FIG. 1, it is understood that the system 100 may comprise any number of additional wireless access points. The system 100 may be substantially co-located with a hospital or other medical service provider location or it may be distributed over multiple locations with appropriate communication links provided via the network 108.

The pain score data input device 102, hereinafter referred to as the input device 102, may be any of a variety of electronic communication devices including a mobile phone, a personal digital assistant, a laptop computer, a tablet computer, a desktop computer, and other. In some embodiments, the input device 102 may be suitably implemented as a wireless handset. Wireless handsets are described in detail hereinafter. The input device 102 receives current pain scores associated with a patient undergoing a pain treatment, for example a patient recovering from a surgical procedure such as a hip replacement or other. In some circumstances, the patient may enter the current pain score into the input device 102. In other circumstances, a medical attendant may query the patient to obtain the current pain score, and the medical attendant may enter the current pain score into the input device 102. The input device 102 may prompt for the current pain score periodically, for example six times per day or some other effective number.

In an embodiment, a pain management application (PMA) client 109 may be installed on the input device 102. The pain management application client 109 may present an interface to prompt for and to receive inputs from a keyboard, touch screen, or other input mechanism of the input device 102. The pain management application client 109 may present a graphical user interface (GUI), for example a dialog box or a frame, to the patient and/or the medical attendant. The current pain score inputs may include, but are not limited to, a pain numerical value, a complication type value, a complication numerical value, and other. The pain numerical value may be a value in the range from 0 to 100 or from 1 to 100, in the range 0 to 10 or 1 to 10, or some other suitable numerical range. The pain numerical value may be an integer value or a decimal value. In an embodiment, increasing values of the pain numerical value are associated with increasing acuity of the pain, but in another embodiment the lower the value of the pain numerical value, the higher the acuity of the pain. Similarly, the complication numerical value may be a value in the range from 0 to 100 or from 1 to 100, in the range 0 to 10 or 1 to 10, or some other suitable numerical range. The complication numerical value may be an integer value or a decimal value. In an embodiment, increasing values of the complication numerical value are associated with increasing acuity of the complication condition, but in another embodiment the lower the value of the complication numerical value, the higher the acuity of the complication condition. Complication type values may be associated with a loss of bowel control condition, a loss of bladder control condition, an itching condition, a vertigo condition, a nauseated condition, a loss of appetite condition, a chest pain condition, an elevated blood pressure condition, a decreased blood pressure condition, an emotional depression, and other conditions. The pain score information may further include an identity of the patient.

The scanner device 120 may be a handheld scanner or other type of scanner that may be used to scan and read information from an admission bracelet of a patient and/or from an identification placard on the controlled medication delivery system 126. The information on the admission bracelet may include an identity of the patient, an identity of an attending physician, an identity of the healthcare facility, a date of admission, a medical condition, and other information. The information about the controlled medication delivery system 126 may include an identity, a type of device, a serial number, a model number, a calibration date, a service date, and other information. The information may be encoded in a standard barcode format, a two dimensional barcode format, a SEMACODE format, a ShotCode format, and/or other formats known to those of skill in the art.

When the scanner device 120 scans the information on the admission bracelet of the patient, the scanner device 120 may transmit the information wirelessly to the first wireless access point 106, through the network 108, to the pain management server 104. The pain management application 110 may write the information, for example, to the set of patient records 116 in the pain management application database 112. When the scanner device 120 scans the information on the placard attached to the controlled medication delivery system 126, the scanner device 120 may transmit the information wirelessly to the first wireless access point 106, through the network 108, to the pain management server 104. The pain management application 110 may write the information, for example, to the set of equipment records 118 in the pain management application database 112. Alternatively, the scanner device 120 may transmit the information over a wired link to the network 108 and through the network 108 to the pain management server 104.

The pain management application client 109 transmits the current pain score to the pain management server 104. In an embodiment, the input device 102 is wirelessly enabled and communicates via a wireless link to the first wireless access point 106. The input device 102 may communicate with the first wireless access point 106 using any of a variety of wireless communication techniques including BlueTooth, WiFi, code division multiple access (CDMA), global system for mobile communications (GSM), worldwide interoperability for microwave access (WiMAX), and other. The input device 102 may communicate with the first wireless access point 106 using the industrial, scientific, and medical (ISM) radio spectrum band. The first wireless access point 106 communicates with the network 108, and the network 108 communicates with the pain management server 104. In another embodiment, however, the input device 102 may communicate with the network 108 via a wired communication link.

The first wireless access point 106 and the second wireless access point 124 may be any of a variety of wireless access points, wireless base stations, wireless hubs, and/or femtocells. A femtocell, also known as an access point base station, may be a small cellular base station. The first wireless access point 106 and the second wireless access point 124 may be implemented as a general purpose computer. General purpose computers are discussed in detail hereinafter. The first wireless access point 106 and the second wireless access point 120 may further provide a wireless local area network (WLAN) communication functionality to the system 100, providing wireless access to the network 108 to a variety of other devices (not shown). The network 108 may be any communication network and may comprise portions of the public switched telephone network (PSTN), portions of the public data network (PDN), and portions of the public land mobile network (PLMN).

The controlled medication delivery system 126 may be any suitable device for delivering a pain medication fluid or gel to a patient. In an embodiment, the controlled medication delivery system 126 may be one of an epidural infusion pump, a nerve block pump, and a patient-controlled analgesia pump, but in other embodiments different types of controlled medication delivery systems may be employed. Each specific type and/or model variation of controlled medication delivery system 126 may have different maintenance schedules prescribed by the subject manufacturers. In some cases, however, the controlled medication delivery system 126 of specific types and/or specific model number may exhibit degraded performance before a corrective scheduled maintenance activity, for example a scheduled overhaul. The accuracy of medication delivery by the controlled medication delivery system 126 may begin to oscillate ±1%, ±2%, or ±5% of a calibrated delivery rate several weeks or months before the scheduled maintenance activity. The degraded performance may be manifested in an anomalous sequence of pain scores, as the changing pain medication delivered alternates between too little and too much. Alternatively, the degraded performance may be manifested by a simple trend over several patients, for example either consistent and increasing over delivery of medication or consistent and increasing under delivery of medication.

The pain management server 104 may be implemented as a general purpose computer or a plurality of general purpose computers. General purpose computers are discussed in detail hereinafter. The pain management application 110 receives the current pain scores and persists them to the pain management application database 112, for example in the set of pain scores 114. The pain management application 110 analyzes the current pain score of the patient in the context of the other pain scores provided by the patient at an earlier time. If the current pain score of the patient is determined to be anomalous, the pain management application 110 may generate an alert message about the anomaly and transmit the alert message to the pager device 122 of a medical attendant, for example a nurse, an anesthesiologist, and/or a physician. The anomaly may be associated with either an unexpected increase or decrease in current pain score. The medical attendant may then examine the patient and/or adjust the controlled medication delivery system 126.

The pain management application database 112 may be implemented as a relational database, an object-oriented database, or other suitable database type. The pain management application database 112 may be accessed by other entities, for example admitting personnel, medical attendants, and/or others accessing the set of patient records 116 and/or the set of equipment records 118. While illustrated in FIG. 1 as encapsulated in the pain management application database 112, in an embodiment, the set of pain scores 114, the set of patient records 116, and the set of equipment records 118 may be located in separate and distinct databases. The patient record of a patient may provide a linkage between the patient scores of the patient stored in the set of pain scores 114 and the medication delivery mechanism and/or controlled medication delivery system 126 that is used to deliver pain medication to the patient. For example, the patient record of a patient may include the identity of the patient, the pain treatment plan associated with the patient, and the identity of the controlled medication delivery system 126. The set of equipment records 118 may comprise entries associated with various equipment, for example the controlled medication delivery systems 126. Each entry may comprise an identity of a device, the model and type of the device, the serial number of the device, a maintenance history of the device, and other.

The pager device 122 may be any of a variety of portable electronic devices including a mobile phone, a personal digital assistant, a pager, and other. In some embodiments, the pager device 122 may be implemented in a form that shares several aspects with a handset. A handset is discussed in detail hereinafter. In an embodiment, the pager device 122 is wirelessly enabled and communicates via a wireless link to the second wireless access point 124. The pager device 122 may communicate with the second wireless access point 124 using any of a variety of wireless communication techniques including BlueTooth, WiFi, code division multiple access (CDMA), global system for mobile communications (GSM), worldwide interoperability for microwave access (WiMAX), and other. The pager device 122 may communicate with the second wireless access point 124 using the industrial, scientific, and medical (ISM) radio spectrum band. The second wireless access point 124 communicates with the network 108, and the network 108 communicates with the pain management server 104.

The pain management application 110 may analyze the pain scores in the set of pain scores 114 to determine an average pain score and a pain score standard deviation based on statistical analysis of pain scores associated with a first patient and/or pain scores associated with the first patient as well as other patients being treated for a condition similar to the condition of the first patient. In another embodiment, the pain management application 110 may analyze the pain scores in the set of pain scores 114 to determine one or more of an average pain score, a median pain score, a pain score mode, and a sliding window pain score average. In combination with the present disclosure, suitable methods of determining an average pain score, a median pain score, a pain score mode, a sliding window pain score average, and a pain score standard deviation can be readily determined by one of ordinary skill in the statistical arts. A sliding window pain score average may be determined as an average calculated over a selected subset of pain scores, for example an average calculated over the most recent three pain scores.

The pain management application 110 may compare the current pain score, for example a current pain numerical value, to a reference pain score, for example an average pain numerical value. If the current pain score falls short of the reference pain score by more than a predefined threshold number of standard deviations, an alert condition may be determined by the pain management application 110. This condition may be indicative of excessive delivery of pain medication to the first patient, a potentially dangerous condition. In an embodiment, the predefined threshold number of standard deviations may be two standard deviations. In another embodiment, however, a different threshold number of standard deviations may be employed, including a fractional number of standard deviations, for example 1.5 standard deviations. The reference pain score may be determined as the average pain numerical value, the median pain numerical value, the pain numerical value mode, or a sliding window average of the pain numerical value.

Similarly, if the current pain score exceeds the reference pain score by more than the predefined threshold number of standard deviations, an alert condition may be determined by the pain management application 110. This condition may be indicative of insufficient delivery of pain medication to the first patient, a potentially unnecessary and correctible condition. In some embodiments, the predefined thresholds may be defined as a specific high pain score threshold and a specific low pain score threshold, rather than in terms of standard deviations from the reference pain score. In this embodiment, when the new pain score drops below the low pain threshold or when the new pain score rises above the high pain threshold, an alert condition may be determined by the pain management application 110. The specific high pain score threshold and the specific low pain threshold may be defined for each different pain treatment plan, condition, and/or injury. When an alert condition is determined, the pain management application 110 transmits the alert message to the pager device 122. The alert message may include a variety of information including the identity of the first patient, the location of the first patient, the pain medication being administered to the first patient, a condition that the first patient is being treated for, and other.

The pain management application 110 may analyze pain scores associated with a type of controlled medication delivery system 126 to determine a distinctive or characteristic signature of a sequence of pain scores that can be associated with a performance degradation of the controlled medication delivery system 126. For example, a sequence of pain scores may be very consistent over a succession of patients, each treated using the same controlled medication delivery system 126. Then the pain scores input by a patient or a series of patients that are treated using the same controlled medication delivery system 126 may begin to have varying values, for example, pain numerical scores which are higher, then lower, then again higher. The signature of oscillating pain scores may be determined to indicate degraded performance of the controlled medication delivery system 126. The identification of a pain score sequence matching the signature of oscillating pain scores may be used by the pain management application 110 to send a maintenance alert message to the pager 122. The degraded controlled medication delivery system 126 may be replaced and either maintained or decommissioned from further service. While manufacturers may provide a recommended maintenance schedule, for example recommending overhaul of the controlled medication delivery system 126 every 1000 hours of use, or every 2000 hours of use, or some other effective period of use, there may be some variation among individual units, and sub-standard performance may decrease the overall patient satisfaction.

While an oscillating pain score signature was described above, other pain score signatures, patterns, and trends may also be indicative of degraded performance of the controlled medication delivery system 126 and may be used by the pain management application 110 to trigger generation and transmission of the maintenance alert message to the pager 122. Hereinafter, all of these will be collectively referred to with the term signature. A pain score signature need not involve the current pain score exceeding a pain score threshold or dropping below a pain score threshold, for example rising more than two standard deviations above or dropping more than two standard deviations below the pain score average. A pain score signature may be defined based on a first derivative or a second derivative of the pain score average with respect to time. A pain score signature may be based on a specific periodic fluctuation of the pain scores, for example a saw tooth wave periodic fluctuation. A pain score signature may be based on a specific general trend of pain scores. For example, for each of a succession of patients treated with the same controlled medication delivery system 126 pain scores that consistently increase for each patient with respect to earlier pains scores for the subject patient. As another example, for each of a succession of patients treated with the same controlled medication delivery system 126 pain scores that consistently decrease for each patient with respect to earlier pain scores for the subject patient. In some cases, the pain score signature may be more discernible over several patients, for example three to seven patients. A pain score signature may be defined based on a frequency of occurrence of alert conditions.

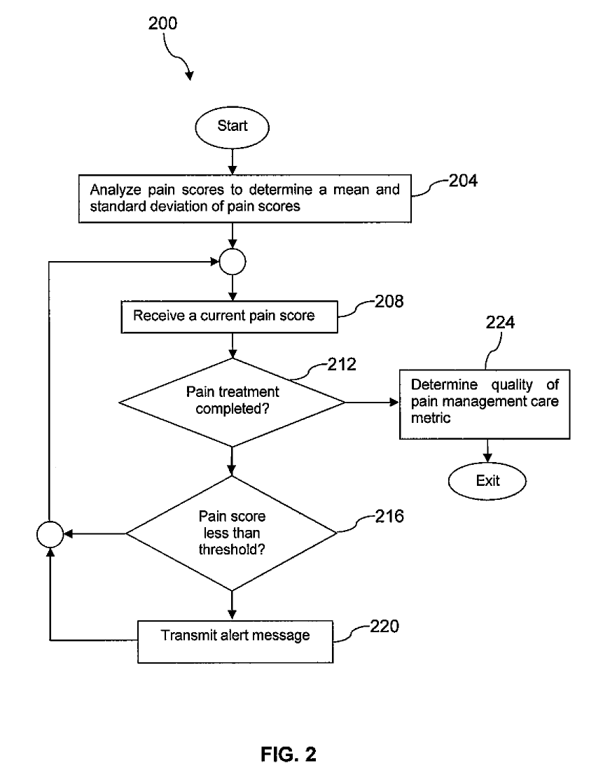

Turning now to FIG. 2, a flow chart of a method 200 of managing pain is now described. At block 204 pain scores are analyzed to determine an average and a standard deviation of pain scores, for example pain numerical scores. In combination with the present disclosure, one of ordinary skill in the statistics art will readily be able to select an effective method of determining the average and standard deviation of the pain scores. The average and standard deviation may be determined based only on the scores of the subject patient or may be determined based on the scores of the subject patient and the scores of other patients who have been given a similar pain management treatment under a similar condition. While the discussion following is directed to the use of the average pain score, it is understood that in some embodiments other pain score references may be calculated and employed in a manner similar to that using the average pain score. For example, the pain score reference may be calculated as a median pain score, a pain score mode, and/or a sliding window average of the pain scores.

At block 208, a current pain score is received. The current pain score may be entered using the input device 102 and transmitted by the input device 102 via the network 108 to the pain management server 104. The pain management application 110 may store the current pain score in the set of pain scores 114 stored in the pain management application database 112. At block 212, if the pain treatment has been completed, a quality of pain management care metric may be determined at block 224. The process then exits.

The quality of pain management care metric, which may also be referred to as a quality of care metric or an overall patient satisfaction metric, may be based on one or more factors comprising a maximum pain numerical value, an average of pain scores for a patient, an aggregate of slope values of the delta between pain scores, a stability and/or steadiness of the pain numerical values, a presence of complications, the complication type values, the complication numerical values, and others. In general, the quality of pain management care metric may be determined as a weighted sum of quality factors represented symbolically as:

QPMC=Σ c₁*F₁+c₂*F₂+ . . . cₙ*Fₙ (Eq. 1)

where QPMC represents the quality of pain management care metric; where c₁, c₂, cₙ are weighting coefficients; and where F₁, F₂, and Fₙ are the values of the different quality factors contributing to the calculation of the quality of pain management care metric.

For different conditions and/or for different pain treatment plans, different combinations of quality factors may be selected for use in determining the quality of pain management care metric. For example, in a first circumstance, the quality of pain management care metric may be determined as the weighted sum of the complication value and the maximum pain. In a second circumstance, the quality of pain management care metric may be determined as the weighted sum of the variability of pain scores and the maximum pain. In a third circumstance, the quality of pain management care metric may be determined as the weighted sum of an average pain numerical value and the average complication numerical value. In a fourth circumstance, the quality of pain management care metric may comprise a weighted sum of the average pain numerical value and a complication aggregate score. The complication aggregate score may be a weighted sum of complication numerical values, represented symbolically as

CAS=k₁V₁+k₂V₂+ . . . +kₘVₘ (Eq. 2)

where CAS represents the complication aggregate score; where k₁, k₂, kₙ are weighting coefficients; and where V₁, V₂, and Vₙ are the values of the different complication numerical values contributing to the calculation of the complication aggregate score. This general structure of determining the complication aggregate score promotes capturing the experience that some complications are more disturbing or more unpleasant to patients than other complications.

At block 212, if the pain treatment is not completed, the process proceeds to block 216. At block 216, if the pain score is less than a predefined threshold number of standard deviations below the average pain score, the process proceeds to block 220. At block 220, an alert message is generated and transmitted, for example to the pager 122 or to another appropriate device. The state of the pain score being less than the threshold value may indicate that too much pain medication is being delivered to the subject patient, a possibly dangerous condition. The process returns to block 208. The method 200 may loop repeatedly through the blocks 204, 208, 212, 216, and optionally 220, at a periodic rate controlled by the pain management application client 109. By this looping the pain management application 110 and the system 100 manages the pain experience of the subject patient.

In another embodiment, block 216 may also check to determine if the pain score exceeds the predefined threshold number of standard deviations above the average pain score and similarly generate and transmit an alert message to the pager 122 or other suitable device. Additionally, in an embodiment, there may be a different threshold number of standard deviations above the average pain score that applies to alerting than the threshold number of standard deviations below the average pain score. While the alerting decision that is performed at block 216 above was determined based on an average pain score, in another embodiment the alerting decision may be performed based on another reference, for example based on a median pain score, a pain score mode, or a sliding window average. In an embodiment, the upper pain score threshold may be a first constant number, unrelated to an average or other statistical figure of merit, and the lower pain score threshold may be a second constant number, unrelated to an average or other statistical figure of merit. In combination with the present disclosure, one of ordinary skill in the statistics arts may choose what particular reference to use for the decision at block 216. In another embodiment, a pain score which does not respond appropriately to a bolus injection administered to the subject patient, for example a pain score that does not drop substantially or that drops too much in response to the bolus injection, may be determined by block 216 and lead to transmitting an appropriate alert message at block 220. Presentation of specific complications, for example chest pains, or presentation of specific combinations of complications, for example chest pains accompanied by elevated blood pressure, may be determined by block 216 and lead to transmitting an appropriate alert message at block 220. Other events or conditions, for example failure of the controlled medication delivery system 126, involuntary catheter removal, subject patient agitation, and other, may be determined by block 216 and lead to transmitting an appropriate alert message at block 220.

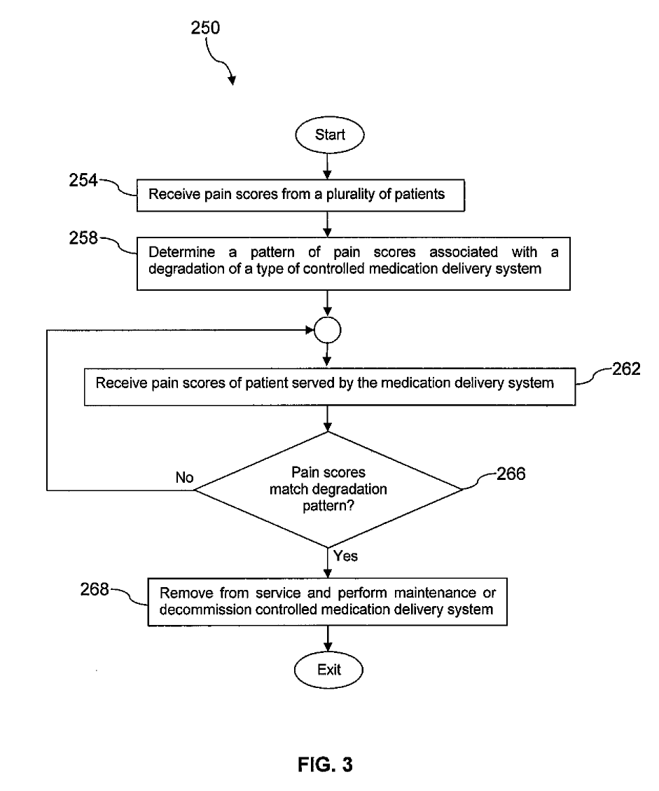

Turning now to FIG. 3, a method 250 of maintaining the controlled medication delivery system 126 is described. In an embodiment, the controlled medication delivery system 126 may be an epidural infusion pump. In other embodiments, however, a different type of pump may be employed. At block 254, a plurality of pain scores from one or more patients treated by a controlled medication delivery system of the same type and model as the controlled medication delivery system 126 are collected and stored in the set of pain scores 114 in the pain management application database 112. The pain scores may be provided by the input device 102 and collected by the pain management application 110. The processing of block 254 may be continued over an extended period of time to accumulate a sufficient sampling of pain scores.

At block 258, one or more signatures of pain scores associated with a degradation of the type and model of pump is determined, based on analyzing the pain scores stored in the set of pain scores 114 in the pain management application database 112. In a first example, a first pump degradation signature may be an alert condition being determined by the pain management application 110 with a frequency greater than a predefined occurrence threshold, for example once per day. In a second example, a second pump degradation signature may be a rate of change of the current pain score, either increasing or decreasing in value, with respect to the previous pain score or the two immediately preceding pain scores that exceeds a predefined rate of change threshold. In a third example, a third pump degradation signature may be a variation calculated over several pain score samples that exceeds a predefined variation threshold, where the variation may be calculated as the absolute value of the difference between the pain score and the average pain score. In another embodiment, the pain score variation may be calculated in a different manner. In a fourth example, a fourth pump degradation signature may be a rate of increase of the variation of the pain value. In a fifth example, a fifth pump degradation signature may be a pain score or a group of pain scores outside of a normal range of pain scores for the subject procedure, injury, and/or pain treatment plan.

At block 262, a current pain score is received from a subject patient being treated using the controlled medication delivery system 126. The current pain score may be provided using the input device 102. At block 266, if the pain scores collected at block 262, for example a sequence of pain scores associated with the controlled medication delivery system 126, exhibit the signature determined in block 258 as characteristic and/or associated with degradation of the type and model of controlled medication delivery system, the processing proceeds to block 268 otherwise the processing returns to block 262. In some cases, the pain scores evaluated at block 266 may be associated with a sequence of several patients treated with the same controlled medication delivery system 126. By looping through blocks 262 and 266, the method 250 monitors the controlled medication delivery system 126 for degraded performance. At block 268, the controlled medication delivery system 126 is removed from service and is maintained or decommissioned.

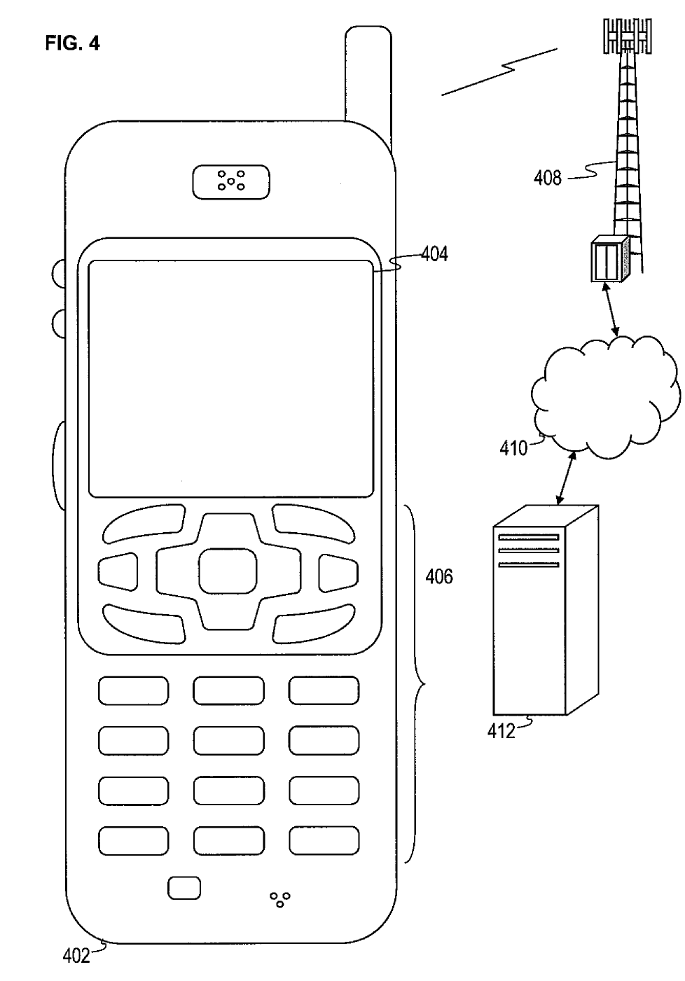

FIG. 4 shows a wireless communications system including a handset 402. FIG. 4 depicts the handset 402, which is operable for implementing aspects of the present disclosure, for example the input device 102, the scanner 120, and the pager 122, but the present disclosure should not be limited to these implementations. Though illustrated as a mobile phone, the handset 402 may take various forms including a wireless handset, a pager, a personal digital assistant (PDA), a portable computer, a tablet computer, or a laptop computer. Many suitable handsets combine some or all of these functions. In some embodiments of the present disclosure, the handset 402 is not a general purpose computing device like a portable, laptop or tablet computer, but rather is a special-purpose communications device such as a mobile phone, wireless handset, pager, or PDA. The handset 402 may support specialized activities such as gaming, inventory control, job control, and/or task management functions, and so on.

The handset 402 includes a display 404 and a touch-sensitive surface or keys 406 for input by a user. The handset 402 may present options for the user to select, controls for the user to actuate, and/or cursors or other indicators for the user to direct. The handset 402 may further accept data entry from the user, including numbers to dial or various parameter values for configuring the operation of the handset. The handset 402 may further execute one or more software or firmware applications in response to user commands. These applications may configure the handset 402 to perform various customized functions in response to user interaction. Additionally, the handset 402 may be programmed and/or configured over-the-air, for example from a wireless base station, a wireless access point, or a peer handset 402.

The handset 402 may execute a web browser application which enables the display 404 to show a web page. The web page may be obtained via wireless communications with a cell tower 408, a wireless network access node, a peer handset 402 or any other wireless communication network or system. The cell tower 408 (or wireless network access node) is coupled to a wired network 410, such as the Internet. Via the wireless link and the wired network, the handset 402 has access to information on various servers, such as a server 412. The server 412 may provide content that may be shown on the display 404. Alternately, the handset 402 may access the cell tower 408 through a peer handset 402 acting as an intermediary, in a relay type or hop type of connection.

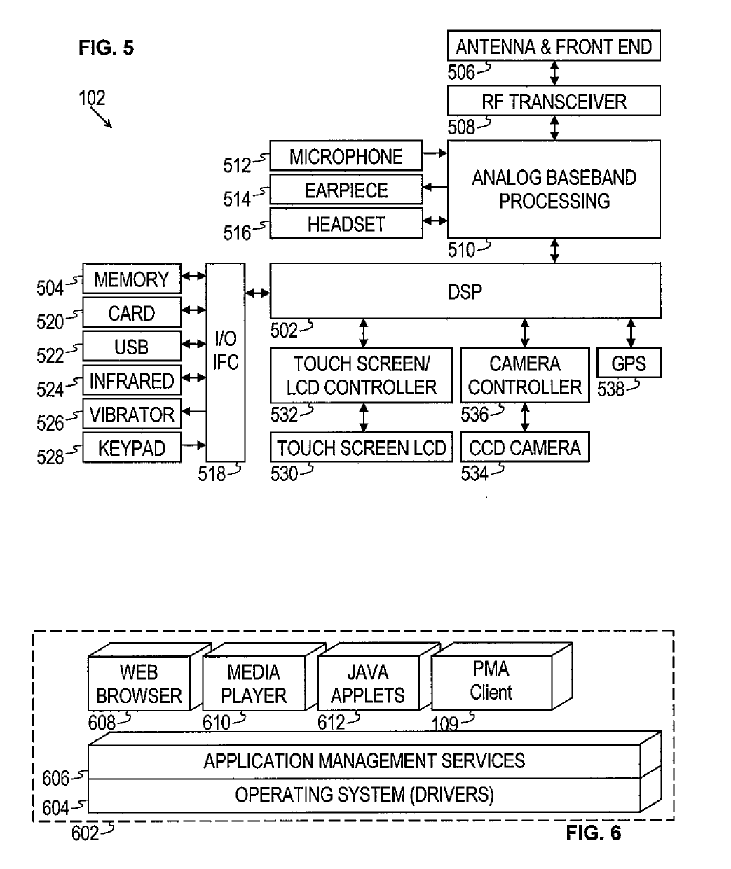

FIG. 5 shows a block diagram of the handset 402. While a variety of known components of handsets 402 are depicted, in an embodiment a subset of the listed components and/or additional components not listed may be included in the handset 402. The handset 402 includes a digital signal processor (DSP) 502 and a memory 504. As shown, the handset 402 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, an infrared port 524, a vibrator 526, a keypad 528, a touch screen liquid crystal display (LCD) with a touch sensitive surface 530, a touch screen/LCD controller 532, a charge-coupled device (CCD) camera 534, a camera controller 536, and a global positioning system (GPS) sensor 538. In an embodiment, the handset 402 may include another kind of display that does not provide a touch sensitive screen. In an embodiment, the DSP 502 may communicate directly with the memory 504 without passing through the input/output interface 518.

The DSP 502 or some other form of controller or central processing unit operates to control the various components of the handset 402 in accordance with embedded software or firmware stored in memory 504 or stored in memory contained within the DSP 502 itself. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the handset 402 to send and receive information from a cellular network or some other available wireless communications network or from a peer handset 402. In an embodiment, the antenna and front end unit 506 may include multiple antennas to support beam forming and/or multiple input multiple output (MIMO) operations. As is known to those skilled in the art, MIMO operations may provide spatial diversity which can be used to overcome difficult channel conditions and/or increase channel throughput. The antenna and front end unit 506 may include antenna tuning and/or impedance matching components, RF power amplifiers, and/or low noise amplifiers.

The RF transceiver 508 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 510 and/or the DSP 502 or other central processing unit. In some embodiments, the RF transceiver 508, portions of the antenna and front end 506, and the analog baseband processing unit 510 may be combined in one or more processing units and/or application specific integrated circuits (ASICs).

The analog baseband processing unit 510 may provide various analog processing of inputs and outputs, for example analog processing of inputs from the microphone 512 and the headset port 516 and outputs to the earpiece speaker 514 and the headset port 516. To that end, the analog baseband processing unit 510 may have ports for connecting to the built-in microphone 512 and the earpiece speaker 514 that enable the handset 402 to be used as a cell phone. The analog baseband processing unit 510 may further include a port for connecting to a headset or other hands-free microphone and speaker configuration. The analog baseband processing unit 510 may provide digital-to-analog conversion in one signal direction and analog-to-digital conversion in the opposing signal direction. In some embodiments, at least some of the functionality of the analog baseband processing unit 510 may be provided by digital processing components, for example by the DSP 502 or by other central processing units.

The DSP 502 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 502 may perform modulation, coding, interleaving, and spreading, and for a receiver function the DSP 502 may perform despreading, deinterleaving, decoding, and demodulation. In another embodiment, for example in an orthogonal frequency division multiplex access (OFDMA) technology application, for the transmitter function the DSP 502 may perform modulation, coding, interleaving, inverse fast Fourier transforming, and cyclic prefix appending, and for a receiver function the DSP 502 may perform cyclic prefix removal, fast Fourier transforming, deinterleaving, decoding, and demodulation. In other wireless technology applications, yet other signal processing functions and combinations of signal processing functions may be performed by the DSP 502.

The DSP 502 may communicate with a wireless network via the analog baseband processing unit 510. In some embodiments, the communication may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB port 522 and the infrared port 524. The USB port 522 may enable the handset 402 to function as a peripheral device to exchange information with a personal computer or other computer system. The infrared port 524 and other optional ports such as a Bluetooth interface or an IEEE 802.11 compliant wireless interface may enable the handset 402 to communicate wirelessly with other nearby handsets and/or wireless base stations.

The input/output interface 518 may further connect the DSP 502 to the vibrator 526 that, when triggered, causes the handset 402 to vibrate. The vibrator 526 may serve as a mechanism for silently alerting the user to any of various events such as an incoming call, a new text message, and an appointment reminder.

The keypad 528 couples to the DSP 502 via the interface 518 to provide one mechanism for the user to make selections, enter information, and otherwise provide input to the handset 402. Another input mechanism may be the touch screen LCD 530, which may also display text and/or graphics to the user. The touch screen LCD controller 532 couples the DSP 502 to the touch screen LCD 530.

The CCD camera 534 enables the handset 402 to take digital pictures. The DSP 502 communicates with the CCD camera 534 via the camera controller 536. The GPS sensor 538 is coupled to the DSP 502 to decode global positioning system signals, thereby enabling the handset 402 to determine its position. In another embodiment, a camera operating according to a technology other than charge coupled device cameras may be employed. Various other peripherals may also be included to provide additional functions, e.g., radio and television reception.

FIG. 6 illustrates a software environment 602 that may be implemented by the DSP 502. The DSP 502 executes operating system drivers 604 that provide a platform from which the rest of the software operates. The operating system drivers 604 provide drivers for the handset hardware with standardized interfaces that are accessible to application software. The operating system drivers 604 include application management services (“AMS”) 606 that transfer control between applications running on the handset 402. Also shown in FIG. 6 are a web browser application 608, a media player application 610, and JAVA applets 612. The web browser application 608 configures the handset 402 to operate as a web browser, allowing a user to enter information into forms and select links to retrieve and view web pages. The media player application 610 configures the handset 402 to retrieve and play audio or audiovisual media. The JAVA applets 612 configure the handset 402 to provide games, utilities, and other functionality. The pain management application client 109 has been discussed above.

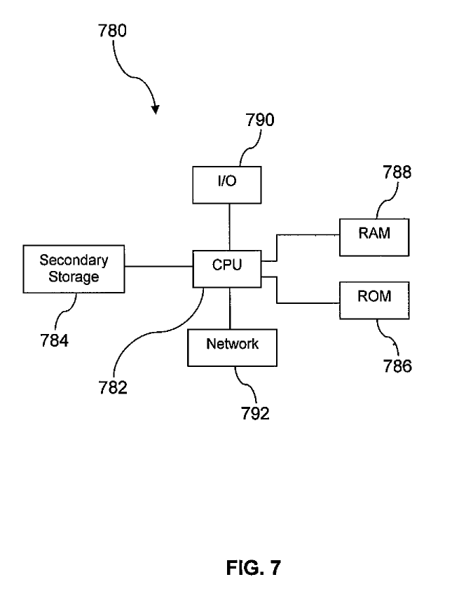

Some aspects of the system described above, for example the pain management server 104, and the wireless access points 106, 124, may be implemented on any general purpose computer with sufficient processing power, memory resources, and network throughput capability to handle the necessary workload placed upon it. FIG. 7 illustrates a typical, general-purpose computer system suitable for implementing one or more embodiments disclosed herein. The computer system 780 includes a processor 782 (which may be referred to as a central processor unit or CPU) that is in communication with memory devices including secondary storage 784, read only memory (ROM) 786, random access memory (RAM) 788, input/output (I/O) devices 790, and network connectivity devices 792. The processor may be implemented as one or more CPU chips.

The secondary storage 784 is typically comprised of one or more disk drives or tape drives and is used for non-volatile storage of data and as an over-flow data storage device if RAM 788 is not large enough to hold all working data. Secondary storage 784 may be used to store programs which are loaded into RAM 788 when such programs are selected for execution. The ROM 786 is used to store instructions and perhaps data which are read during program execution. ROM 786 is a non-volatile memory device which typically has a small memory capacity relative to the larger memory capacity of secondary storage. The RAM 788 is used to store volatile data and perhaps to store instructions. Access to both ROM 786 and RAM 788 is typically faster than to secondary storage 784.

I/O devices 790 may include printers, video monitors, liquid crystal displays (LCDs), touch screen displays, keyboards, keypads, switches, dials, mice, track balls, voice recognizers, card readers, paper tape readers, or other well-known input devices.

The network connectivity device 792 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), and/or worldwide interoperability for microwave access (WiMAX) radio transceiver cards, and other well-known network devices. The network connectivity devices 792 may include a radio transceiver card that promotes communication in the industrial, scientific, and medical (ISM) radio frequency band. These network connectivity devices 792 may enable the processor 782 to communicate with an Internet or one or more intranets. With such a network connection, it is contemplated that the processor 782 might receive information from the network, or might output information to the network in the course of performing the above-described method steps. Such information, which is often represented as a sequence of instructions to be executed using processor 782, may be received from and outputted to the network, for example, in the form of a computer data signal embodied in a carrier wave

Such information, which may include data or instructions to be executed using processor 782 for example, may be received from and outputted to the network, for example, in the form of a computer data baseband signal or signal embodied in a carrier wave. The baseband signal or signal embodied in the carrier wave generated by the network connectivity devices 792 may propagate in or on the surface of electrical conductors, in coaxial cables, in waveguides, in optical media, for example optical fiber or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 782 executes instructions, codes, computer programs, scripts which it accesses from hard disk, floppy disk, optical disk (these various disk based systems may all be considered secondary storage 784), ROM 786, RAM 788, or the network connectivity devices 792. While only one processor 782 is shown, multiple processors may be present. Thus, while instructions may be discussed as executed by a processor, the instructions may be executed simultaneously, serially, or otherwise executed by one or multiple processors.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A pain management system, comprising:
a database containing a plurality of pain scores associated with a first patient; and
a pain management server, in communication with the database, comprising
a processor and
a pain management application that, when executed by the processor, receives a first pain score associated with the first patient, analyzes the first pain score based at least in part on the plurality of pain scores associated with the first patient in the database, and when the first pain score drops below a first threshold determined by the analysis transmits an alert.

2. The pain management system of claim 1, wherein the pain scores comprise at least one of a pain numerical value, a pain category value, a complication category value, a complication numerical value, and a time and date value.

3. The pain management system of claim 1, wherein the database includes treatment and health record information about the first patient and the pain scores associated with the first patient are linked to the treatment and health record information about the first patient.

4. The pain management system of claim 1, further including a device that administers the pain medication to the first patient, wherein the device is adjusted to manage the pain experienced by the first patient.

5. The pain management system of claim 1, wherein when the first pain score raises above a second threshold determined by the analysis the pain management application transmits an alert.

6. The pain management system of claim 1, wherein the database further contains a plurality of pain scores associated with a second patient and wherein the analysis of the first pain score is further based on the plurality of pain scores associated with the second patient.

7. A method of pain management, comprising:
analyzing a plurality of pain scores associated with a first patient to determine a standard deviation of the pain scores;
receiving a current pain score associated with the first patient;
when the current pain score drops below a first threshold defined based on the standard deviation of the pain scores, transmitting a first alert message.

8. The method of claim 7, further including analyzing a plurality of pain scores associated with a second patient and wherein the standard deviation of the pain scores is further based on the pain scores associated with the second patient.

9. The method of claim 8, wherein the pains scores associated with the first patient are associated with a first pain medication delivery point, the pain scores associated with the second patient are associated with a second pain medication delivery point, and the first and second pain medication delivery points are substantially the same location.

10. The method of claim 7, wherein the first threshold is further defined with reference to one of an average of the plurality of pains scores, a median of the plurality of pain scores, a mode of the plurality of the pain scores, and a sliding window average of the plurality of pain scores.

11. The method of claim 10, further including determining a quality of pain management care metric based on the pain scores over a duration of a pain management treatment.

12. The method of claim 7, wherein the alert message is transmitted to at least one of a nurse, an anesthesiologist, and a physician.

13. The method of claim 7, further including reducing a rate of delivery of a pain medication to the first patient in response to the first alert message.

14. The method of claim 7, further including:
when the current pain score raises above a second threshold defined based on the standard deviation of the pain scores, transmitting a second alert message; and
increasing the rate of delivery of the pain medication to the first patient in response to the second alert message.

15. A method of pain management equipment maintenance, comprising:
receiving a plurality of pain scores associated with one or more patients receiving pain medication from a first controlled medication delivery system;
analyzing the pain scores to identify a signature of pain scores associated with a performance degradation of the first controlled medication delivery system; and
when the signature of pain scores associated with the performance degradation of the first controlled medication delivery system is identified, removing the first controlled medication delivery system from service for one of performance of maintenance and decommisioning.

16. The method of claim 15, wherein the first controlled medication delivery system is one of an epidural infusion pump, a nerve block pump, and a pain controlled analgesia (PCA) pump.

17. The method of claim 15, further including determining the signature of pain scores associated with the performance degradation of the first controlled medication delivery system by analyzing a plurality of pain scores associated with patients that received pain medication from the same type of controlled medication delivery system as the first controlled medication delivery system.

18. The method of claim 17, wherein the analyzing the plurality of pain scores associated with patients that received pain medication from the same type of controlled medication delivery system as the first controlled medication delivery system is further limited to patients receiving pain medication delivered to substantially the same place.

19. The method of claim 15, further including when the signature of pain scores associated with the performance degradation of the first controlled medication delivery system is identified, transmitting an alert message, wherein the removing the first controlled medication delivery system from service takes place in response to the alert message.

20. The method of claim 15, wherein at least one of pain scores comprise at least one of a pain numerical value, a pain category value, a complication category value, a complication numerical value, and a time and date value.
